(19) United States
(12) Patent Application Publication
(10) Pub. No.: US 2009/0106561 A1
(43) Pub. Date: Apr. 23, 2009

(54) DATA MANAGEMENT APPARATUS AND DATA MANAGEMENT METHOD

(75) Inventor: Taichi EJIRI, Aichi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Buffalo Inc., Nagoya-shi (JP)

(21) Appl. No.: 12/251,851

(22) Filed: Oct. 15, 2008

(30) Foreign Application Priority Data
Oct. 16, 2007 (JP) 2007-269418

(51) Int. Cl. G06F 12/14

(52) U.S. Cl. 713/193

(57) ABSTRACT

A data management apparatus is adaptable to an encryption system using a common key and a pair of keys comprising a public key and a private key. The data management apparatus includes: a common key encryption unit configured to encrypt a first common key with a first public key to generate an encrypted first common key; a password setting receiving unit configured to receive a setting of a first password; and a private key encryption unit configured to encrypt a first private key with the first password to generate an encrypted first private key.

### CROSS-REFERENCE TO RELATED APPLICATIONS

This application is based upon and claims the benefit of priority from Japanese Patent Application No. 2007-269418 filed on Oct. 16, 2007, the entire contents of which are incorporated herein by reference.

### TECHNICAL FIELD

The present invention relates to a data management apparatus, a data management method, and a data management program.

### BACKGROUND

EFS (Encrypting File System) of NTFS (NT File System) is known as a system for blocking data access from everyone except specific persons by encrypting a predetermined storage area. FIG. 14 is a view for explaining the system “EFS”. In EFS, a common key used to encrypt a file is encrypted with a public key of each user. The encrypted common key encrypted with the public key and data encrypted with the common key are stored on a storage area in association with each other. To decrypt the encrypted data, a common key is used which is obtained by decrypting the encrypted common key by use of a private key serving as the counterpart public key. Since the private key includes a random data string, it is difficult for a user to memorize the data string of the private key. Therefore, to enable a user to decrypt the encrypted data, it is necessary to keep the private key on a storage medium while preventing the data from being lost or leaked.

### SUMMARY

However, in the EFS, access to the encrypted data at the time of generating the encrypted data is authorized only to a user who has generated the encrypted data. That is, if the user loses user's own private key, it is impossible to decrypt the encrypted data. Therefore, to prevent the encrypted data from becoming indecipherable, access privileges may be given to a plurality of users (for example, a user who has generated data, an administrator, a user having predetermined authority in a domain, etc.). However, since the management of the private key is entrusted to each user (and administrator), the danger that the private key may be lost or leaked still remains.

The present invention has been made in consideration of these circumstances. It is therefore an object of one aspect of the present invention to provide a data management apparatus and a data management method, and a data management program capable of avoiding a decrease in security resulting from the leakage of information necessary to decrypt pieces of encrypted data and capable of preventing a situation making decryption impossible in spite of the fact that encrypted data is present without being corrupted.

According to an aspect of the invention, there is provided a data management apparatus adaptable to an encryption system using a common key and a pair of keys comprising a public key and a private key, the encryption system in which: an encryption is performed by encrypting plaintext data with the common key to generate encrypted data and generating an encrypted common key by encrypting the common key with the public key; and decryption is performed by decrypting the encrypted common key with the private key to obtain a decrypted common key and decrypting the encrypted data with the decrypted common key, said data management apparatus comprising: a common key encryption unit configured to encrypt a first common key with a first public key to generate an encrypted first common key; a password setting receiving unit configured to receive a setting of a first password; and a private key encryption unit configured to encrypt a first private key with the first password to generate an encrypted first private key.

According to another aspect of the invention, there is provided a data management method adaptable to an encryption system using a common key and a pair of keys comprising a public key and a private key, the encryption system in which: an encryption is performed by encrypting plaintext data with the common key to generate encrypted data and generating an encrypted common key by encrypting the common key with the public key; and decryption is performed by decrypting the encrypted common key with the private key to obtain a decrypted common key and decrypting the encrypted data with the decrypted common key, said data management method comprising: encrypting a first common key with a first public key to generate an encrypted first common key; receiving a setting of a first password; and encrypting a first private key with the first password to generate an encrypted first private key.

According to still another aspect of the invention, there is provided a computer-readable medium having a computer program stored thereon and readable by a computer, said computer program, when executed by the computer, causes the computer to perform operations for a data management apparatus adaptable to an encryption system using a common key and a pair of keys comprising a public key and a private key, the encryption system in which: an encryption is performed by encrypting plaintext data with the common key to generate encrypted data and generating an encrypted common key by encrypting the common key with the public key; and decryption is performed by decrypting the encrypted common key with the private key to obtain a decrypted common key and decrypting the encrypted data with the decrypted common key, said operations comprising: encrypting a first common key with a first public key to generate an encrypted first common key; receiving a setting of a first password; and encrypting a first private key with the first password to generate an encrypted first private key.

### BRIEF DESCRIPTION OF THE DRAWINGS

FIG. 1 is a schematic block diagram showing an authentication system of an embodiment;

FIG. 2 is a flowchart showing the flow of a management process;

FIG. 3 is a view for explaining the management process;

FIG. 4 is a flowchart showing the flow of an encryption initialization process;

FIG. 5 is a view for explaining the encryption initialization process;

FIG. 6 is a flowchart showing the flow of a data encryption process;

FIG. 7 is a flowchart showing the flow of a data decryption process;

FIG. 8 is a view for explaining data decryption and data encryption by a user;

FIG. 9 is a view for explaining data decryption by an administrator;

FIG. 10A is a diagram showing examples of the distribution of password-related information in the authentication system;

FIG. 10B is diagram showing examples of the distribution of password-related information in an authentication system according to another embodiment;

FIG. 11 is a view for explaining the encryption initialization process according to another embodiment;

FIG. 12 is a view for explaining data decryption and data encryption at the user computer of user B according to another embodiment;

FIG. 13 is a view for explaining data decryption at the user computer of user A according to another embodiment; and

FIG. 14 is a view for explaining the general EFS.

### DESCRIPTION

An embodiment of the present invention will be hereinafter described in the following order:

(1) System overview of the embodiment;

(2) Management process;

(3) Encryption initialization process;

(4) Data encryption/decryption process; and

(5) Various modifications.

### (1) System Overview of the Embodiment

An authentication system according to the embodiment of the present invention will be hereinafter described with reference to the drawings.

The authentication system is adaptable to an encryption system using a common key and a pair of keys comprising a public key and a private key. In the encryption system, an encryption is performed by encrypting plaintext data with the common key to generate encrypted data and generate an encrypted common key by encrypting the common key with the public key. The encrypted data is stored in association with the encrypted common key. The decryption is performed by decrypting the encrypted common key with the private key to obtain a decrypted common key and decrypting the encrypted data with the decrypted common key.

The common key is an encryption key according to a common key encryption method. On the other hand, the public key and the private key are a pair of encryption keys generated according to a private key encryption method. The encrypted data encrypted by one of the pair of encryption keys is decrypted only by the other one of the pair of encryption keys. In this embodiment, the encryption key for encrypting a common key is referred to as a “public key”, and the encryption key for decrypting the encrypted common key is referred to as a “private key.”

In the drawings, the encryption process is represented by E_{KEY}(M)→(M)′, whereas the decryption process is represented by D_{KEY}((M)′)→M. Reference character “E” designates an encryption function, reference character “D” designates a decryption function, reference character “KEY” designates an encryption key or a decryption key in each function, reference character “M” designates data that has not yet been encrypted, and reference character (M)′ designates encrypted data. Although the functions are all mentioned by using the characters “E” and “D”, a plurality of encryption or decryption functions different from one another may be used in respective encryption processes.

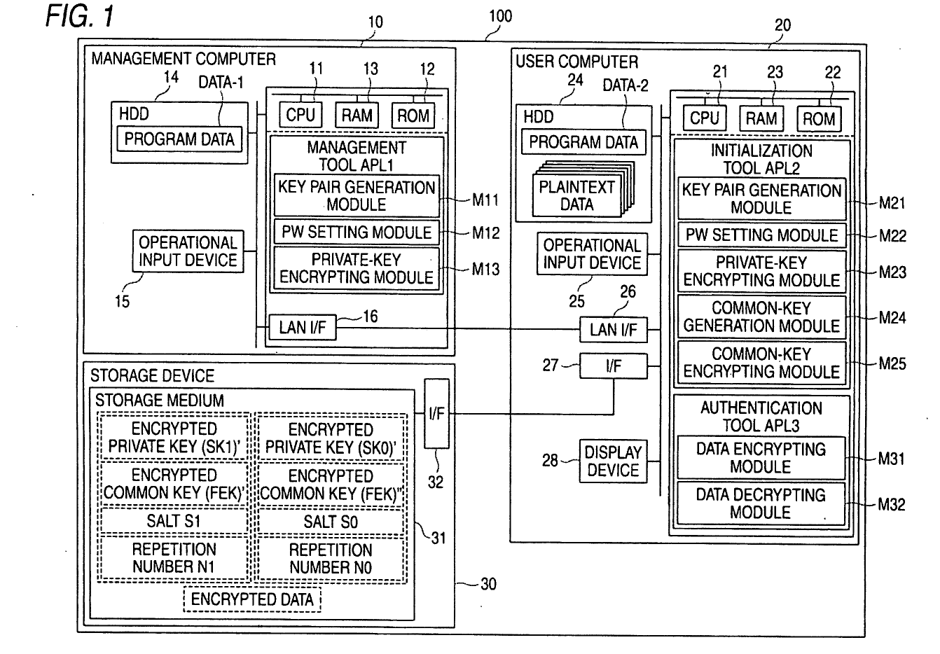

FIG. 1 is a schematic block diagram showing an authentication system of this embodiment. As shown in FIG. 1, an authentication system 100 includes a management computer 10, a user computer 20, and a storage device 30. In the management computer 10, the program is executed by the authority of an administrator (e.g., “Administrator” of WindowsNT (registered trademark) or “root” of UNIX (registered trademark)) having management privileges of the authentication system 100. On the other hand, in the user computer 20, the program is executed by the authority of an ordinary user having no system management privileges. In the following description, the terms “administrator” and “ordinary user” are referred to generically as “user”.

Although the management computer 10 and the user computer 20 are shown as different computers separated from each other in FIG. 1, the management computer 10 and the user computer 20 may operate on a single computer if the single computer has an OS (Operating System) installed thereon which supports user management to distinguish a user having administrator authority from a user having no administrator authority. The storage device 30 may be provided as an internal device of the user computer 20 or as an external device with respect to the user computer 20. However, when the storage device 30 is provided as the internal device, the storage device may be physically or logically separated from a system area of the user computer 20. In this specification, even when a single computer operates for a plurality of users (such as the administrator and the ordinary user) and serves as the management computer 10 and the user computer 20, the computer operating for different users is referred to as different data management apparatuses.

The management computer 10 shown in FIG. 1 includes: a program executing environment including a CPU (Central Processing Unit) 11, a ROM (Read Only Memory) 12, and a RAM (Random Access Memory) 13; a mass storage medium such as a HDD (Hard Disc Drive) 14; and a communication interface such as a LAN I/F (Local Area Network Interface) 16. An operational input device 15 (e.g., a mouse or a keyboard) configured to receive operational input from an administrator is connected to the management computer 10. Program data DATA1 of a management tool APL1 provided as an application is stored in the HDD 14. The management tool APL1 may always be executed during the running of the management computer 10, or may be executed while being properly loaded into the RAM 13 according to a request issued from the user computer 20.

The management tool APL1 includes a key pair generation module M11, a PW (password) setting module M12, and a private-key encrypting module M13. The key pair generation module M11 is configure to generate a pair of unique keys including a public key PK0 and a private key SK0. The PW setting module M12 is configured to receive password input from the administrator and send the input password to the private-key encrypting module M13. The private-key encrypting module M13 is configured to encrypt the private key SK0 with an authentication password PW0 received by the PW setting module M12.

In more detail, the private-key encrypting module M13 is configured to generate a hash value H0 with a predetermined summation function f (PW) from the authentication password PW0 set by the PW setting module M12, and the private key SK0 is encrypted with the hash value H0 as an encryption key, thus generating an encrypted private key (SK0)′. To generate the hash value, salt addition and hash calculation are repeatedly performed. The summation function f(PW) for generating the hash value H is not limited to a unidirectional function, and may be a function for generating a cyclic redundancy code (i.e., code for error checking) of, for example, CRC (Cyclic Redundancy Checking).

The user computer 20 shown in FIG. 1 includes: a program executing environment including a CPU 21, a ROM 22, and a RAM 23; a mass storage medium such as an HDD 24; a communication interface such as a LAN I/F 26; and a predetermined interface 27 (e.g., a USB (Universal Serial Bus) I/F) capable of communicating with the storage device. The LAN I/F 26 is connectable to the LAN I/F 16 of the management computer 10. An operational input device 25 (e.g., a mouse or a keyboard) configured to receive operational input from a user is connected to the user computer 20. A display device 28 is connected to the user computer 20. Data DATA2 concerning an encryption initialization tool APL2 for users (hereinafter, referred to simply as an “initialization tool”) provided as an application and concerning a user/administrator common authentication tool APL3 (hereinafter, referred to simply as an “authentication tool”) is stored on the HDD 24. The initialization tool APL2 and the authentication tool APL3 may always be executed during the running of the user computer, or may be executed while being properly loaded into the RAM 23 according to user's operational input.

The initialization tool APL2 includes a key pair generation module M21, a PW setting module M22, a private-key encrypting module M23, a common-key generation module M24, and a common-key encrypting module M25.

The key pair generation module M21 is configured to generate a pair of unique keys including a public key PK1 and a private key SK1. The PW setting module M22 is configured to receive a password input from an ordinary user and output the input password to the private-key encrypting module M23 in the form of an authentication password PW1 of the ordinary user. The private-key encrypting module M23 is configured to encrypt the private key SK1 with the authentication password PW1 received by the PW setting module M22.

The common-key generation module M24 is configured to create a common key FEK that is used for encrypting plaintext data and decrypting the encrypted plaintext data. Whenever the encryption of a predetermined unit area (e.g., partition, folder, or file) is selected, this common key FEK is created as a unique one between unit areas, and the same common key FEK for each user is used in the same unit area.

The common-key encrypting module M25 is configured to generate an encrypted common key obtained by encrypting a common key FEK with the public key of a user and store the encrypted common key and the encrypted private key generated from a private key paired with the public key used for encrypting the common key FEK on the storage device 30 in association with a unit area. The information for the association is stored in, for example, a header given to the unit area.

The authentication tool APL3 includes a data encrypting module M31 and a data decrypting module M32. The data encrypting module M31 and the data decrypting module M32 are configured to decrypt an encrypted common key to obtain a common key FEK. The data encrypting module M31 is configured to encrypt specified plaintext data with the obtained common key FEK and store the encrypted data on a unit area. The data decrypting module M32 is configured to decrypt a specified encrypted data with the obtained common key FEK and store the plaintext data on the user computer 20.

The storage device 30 shown in FIG. 1 includes a storage medium 31 such as a nonvolatile semiconductor memory or an HD (Hard Disk) and is connectable to the user computer 20 through a predetermined interface 32. The user computer 20 can communicate with the storage device 30 according to a protocol of the interface 32 control the storage device to record desired data on the storage medium. The storage device 30 is not limited to a built-in type device including a storage medium having a fixed amount of storage capacity, and may be a reader/writer to which a removable medium can removably be attached (e.g., flexible disk, MO (Magneto Optical), or memory card).

### (2) Management Process

According to the above system, a user uses the user computer 20 to encrypt desired data and records the encrypted data on the storage device 30. The user further records the encrypted common key and the encrypted private key generated from a private key paired with the public key used for encrypting the common key FEK on the storage device 30. The reason why the encrypted private key is recorded is that data confidentiality is not ensured if the private key SK is recorded as it is. Therefore, as described above, the private key to be recorded on the storage device 30 is encrypted with the password of a user having access privilege to the data.

Generally, an ordinary user “A” as a user of the user computer 20 stores encrypted data in the storage device 30. However, in order to brace for the case where the ordinary user “A” also as a data-generating person cannot decrypt the encrypted data, the encrypted data generated by the ordinary user “A” is set to allow an administrator to decrypt the data. There is another case where a user “B” also uses the encrypted data generated by the ordinary user “A”. For this case, the ordinary user “A” has to generate decryption information for the administrator and decryption information for the user “B” in addition to decryption information for the ordinary user “A”, and store the decryption information on the storage device 30 together with the encrypted data. However, since it is not preferable the administrator distributes the private key as it is to the ordinary users, the management process is performed by the management computer 10 through the following steps, and the private key for the administrator is encrypted, and then the resulting encrypted private key is distributed (communicated) to the ordinary users. Similarly, the user “B” who is one of the ordinary users can decrypt the encrypted data generated by the ordinary user “A” by conducting similar process and distribution.

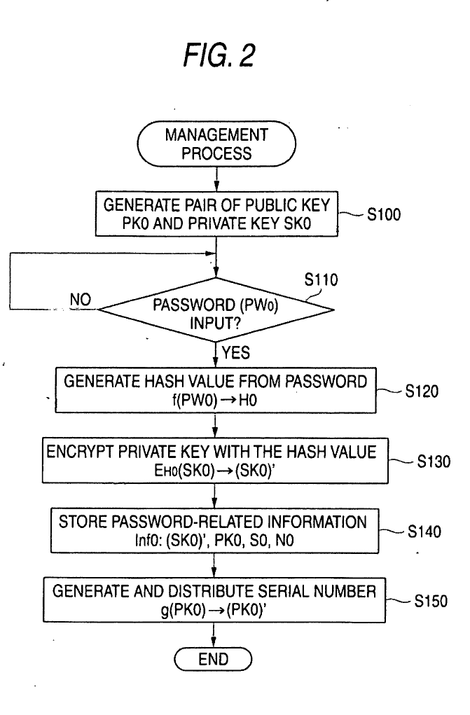

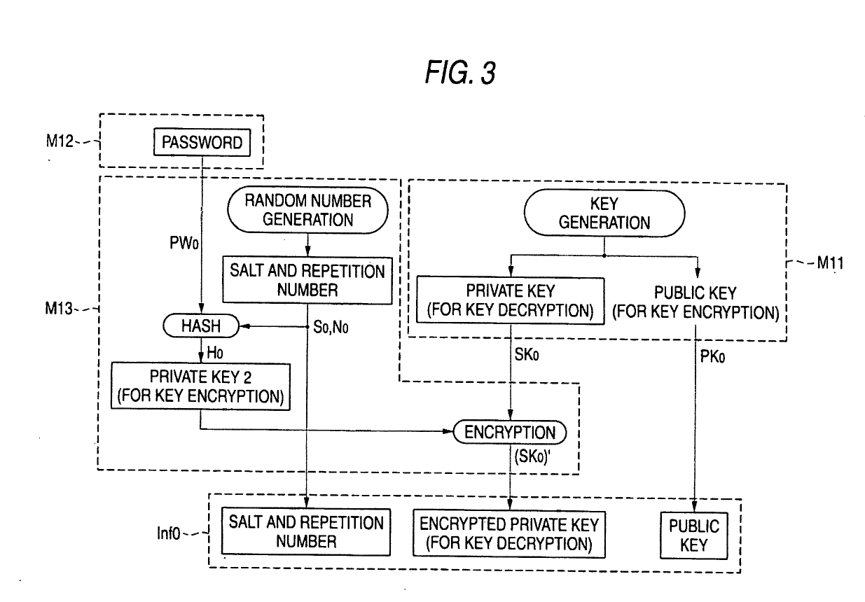

FIG. 2 is a flowchart showing the flow of the management process, and FIG. 3 is a view for explaining the management process. This management process is performed before data is recorded on the storage device 30 by the user computer 20. For example, this process is performed when the management tool APL1 is initialized after the management tool APL1 is installed on the management computer 10.

After the process is started, at the step S100, the key pair generation module M11 generates a pair of keys including a public key PK0 and a private key SK0 for an administrator. The public key PK0 and the private key SK0 are respectively used for encrypting a common key FEK used for data encryption and for decrypting an encrypted common key (FEK)″ stored on a storage device 30 described later. The common key FEK encrypted by the public key PK0 is decrypted by the private key SK0, and hence encrypted data can be generated and decrypted by the common key FEK decrypted thereby.

At step S110 subsequent to step S100, the PW setting module M12 receives the input of an authentication password PW0. In more detail, the PW setting module M12 sets a series of characters input from the operational input device 15 as an authentication password PW0 for an administrator. This series of characters is input from the operational input device 15 during the period from the start of step S110 until the operational input showing the completion of the input of a password. If a login password for the management computer 10 or the like is appropriated for this password input, it is recommended at step S110 to obtain a login password written at a predetermined place of the management computer 10. When the input of the password of step S110 is completed, the process proceeds to step S120.

At step S120, the private-key encrypting module M13 generates a hash value H0 used to encrypt the private key SK0. The hash value H0 is generated from the authentication password PW0. The hash value H0 is generated by the following process including: generating random numbers; and then determining data (salt) to be added to the authentication password PW0 that forms a basis for a hash calculation and the number of times the hash calculation is repeatedly performed (repetition number). Thereafter, whenever the hash calculation is repeatedly performed, the salt S0 is added, and the hash calculation is performed a number of times specified by the repetition number N0, thus generating the hash value H0. The private key SK0 is encrypted by the hash value H0 according to the common key encryption method. Since the salt S0 or the repetition number N0 is specified in this way when the private key SK0 is encrypted, the hash value H0 (common key) is sufficiently opposable against a dictionary attack. Additionally, since the salt S0 and the repetition number N0 are determined based on random numbers, the repetition number and the salt generated whenever the hash value H0 is generated are hardly estimated, and hence the security of the encrypted private key is heightened. In other words, on hashing the password to improve the confidentiality of encrypted data, the salt is added to the password, which allows the character string serving as a basis to generate a hash value not to be a simple character string. In addition, the randomness of the generated hash value is heightened by setting the repetition number of a hash calculation. Therefore, even if an attempt to decipher the password is made by a brute force attack, such as a dictionary attack, the processing time required to decipher the password increases since the salt has to be added to the character string in the dictionary and the hash calculation has to be performed the repetition number. Therefore, it is practically impossible to decrypt the encrypted private key.

At step S130 subsequent to step S120, the private-key encrypting module M13 encrypts the private key SK0 by use of the hash value H0, and generates an encrypted private key (SK0)′. The encryption of the private key SK0 with the hash value H0 allows the private key SK0 to be stored in a place accessible by many and unspecified persons, unlike the related art system requiring the private key to be kept confidential and be managed. Therefore, it becomes unnecessary to keep the private key SK0 within the management computer 10, and it becomes possible to reduce the possibility of a loss of the private key SK0 by storing the encrypted private key (SK0)′ in an arbitrary place.

At step S140 subsequent to step S130, the private-key encrypting module M13 stores the repetition number N0, the salt S0, the encrypted private key (SK0)′, and the public key PK0 of the administrator as password-related information Inf0 on a predetermined storage area such as an external removable storage device connectable to the management computer 10, the HDD 14, the RAM 13, etc. This password-related information Inf0 is output to an ordinary user (or the user computer 20 used by the ordinary user) according to a request sent from the ordinary user (or the user computer 20 used by the ordinary user). Since it is difficult for a person to memorize or re-input the password-related information Inf0, it is desirable to be electronically output to the user computer 20. However, of course, the password-related information Inf0 may be distributed directly to ordinary users through the medium of paper, or may be communicated to ordinary users by, for example, e-mails.

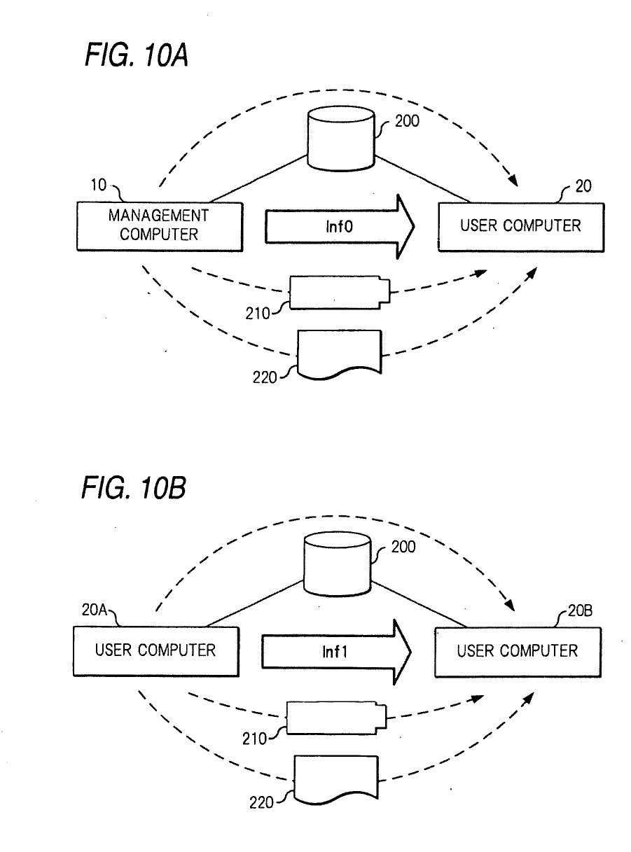

Various examples of the distribution of the password-related information Inf0 are shown in FIG. 10A. For example, the management computer 10 may output the password-related information Inf0 to a storage device 200 which can commonly accessible from the management computer 10 and the user computer 20, such as an external storage device (e.g., a server located on a network) or a hard disk built in a computer when the management computer 10 and the user computer 20 operate on a same computer. The user computer 20 can receive the password-related information Inf0 by accessing the storage device 200. Further, the management computer 10 may output the password-related Inf0 to a removable storage device 210. The user computer 20 can receive the password-related information Inf0 by mounting the removable storage device 210. Still further, the management computer 10 may print the password-related Inf0 on a printable medium 220 such as paper. The user computer 20 can receive the password-related information Inf0 by inputting the password-related Inf0 printed on the printable medium 220 via an input device such as a keyboard, a scanner, etc.

A serial number Ser may be distributed from an administrator to an ordinary user to prevent the password-related information Inf0 from being falsified, in addition to the distribution of the password-related information Inf0. The serial number Ser may be distributed from the management computer 10 (or the administrator) to the user computer 20 (or user) via arbitrary route to which examples shown in FIG. 10A is applicable. This serial number Ser is generated based on the public key PK0. For example, a hash value generated by substituting the public key PK0 for a predetermined hash function g may be used therefor. This serial number Ser is distributed to an ordinary user via a different distribution route (e.g., paper medium) than the password-related information Inf0. For example, the management computer 10 includes two different output device configured to output the password-related information Inf0 and the serial number Ser, respectively. In the example shown in FIG. 1, the management computer 10 outputs the password-related information Inf0 from the LAN I/F 16 serving as a first output device and outputs the serial number Ser from a printer connected to the computer 10 via a print controller contained in the management computer 10 serving as a second output device. The ordinary user makes a comparison between a hash value generated from the public key PK0 according to a predetermined hash calculation performed by the user computer 20 and the distributed serial number Ser, and confirms the presence or absence of the falsification of the password-related information Inf0. That is, in an environment in which the password-related information Inf0 cannot be safely delivered to the user computer 20 (e.g., in-house LAN used by many members), even when the password-related information Inf0 is fraudulently substituted on transmitting the password-related information Inf0 to from the management computer 10 to the user computer 20, the use of the serial number Ser overcomes security vulnerability due to the fraudulent substitution that allows encrypted data to be decrypted with a password that is not intended by a right user (administrator).

Specifically, in the management process, after step S140 is completed, step S150 is performed at which a hash value is calculated from the public key PK0 according to a predetermined hash calculation, and is defined as a serial number Ser. This serial number Ser is distributed to each ordinary user. For example, a paper medium having the serial number Ser written thereon and printed by a printer connected to the management computer 10 or duplicated on a sheet of paper by an administrator is delivered to each user. Of course, the serial number Ser is not necessarily distributed through the paper medium. If it is distributed via a distribution route different from that of password-related information Inf0, a variety of distribution methods can be employed. For example, the serial number Ser and the password-related information Inf0 may be transmitted to the user computer 20 via physically/logically different communication lines or networks. For example, the management computer 10 may include another communication interface, and the password-related information Inf0 and the serial number Ser may be output from the LAN I/F 16 and the another communication interface, respectively. Further, the serial number Ser and the password-related information Inf0 may be transmitted to the user computer 20 via the same communication line or network at different timings. For example, the management computer 10 may output the password-related information Inf0 from the LAN I/F 16 and thereafter output the serial number Ser from the LAN I/F 16. That is, the LAN I/F 16 is the same output device but serves as two output units configured to output the password-related information Inf0 and the serial number Ser but serves, respectively. Further, the management computer 10 may output the password-related information Inf0 and the serial number Ser from an interface connectable to a removable memory device, and the password-related information Inf0 and the serial number Ser may be stored on different memory devices. In this case, the same output device (interface for removable memory device) is used for outputting the password-related information Inf0 and the serial number Ser at different timings but serves as two output units configured to output different information. Accordingly, the password-related information Inf0 and the serial number Ser may be output from the management computer 10 from the different output device and/or at the different timings.

The management process is completed through these steps, and the encryption initialization by the user computer 20 is ready to be performed.

### (3) Encryption Initialization Process

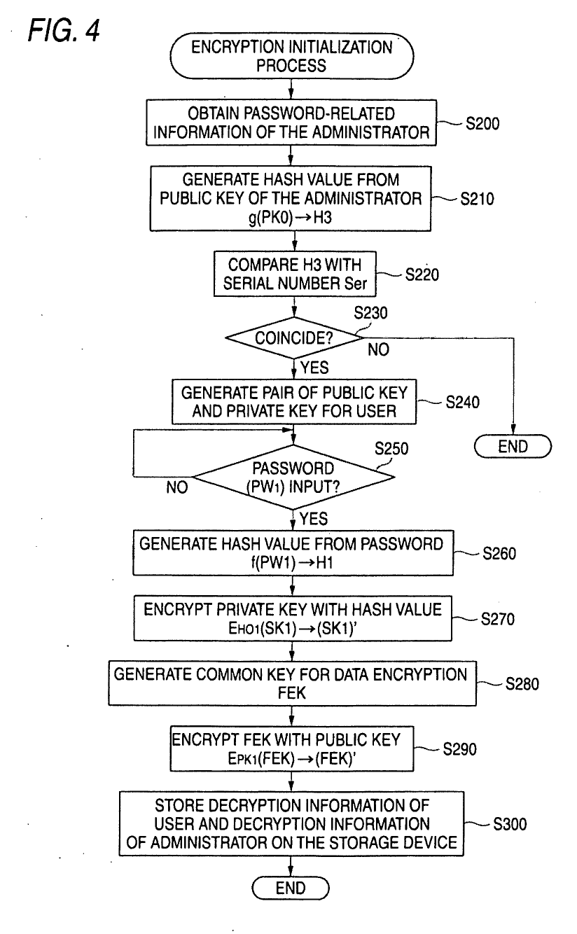

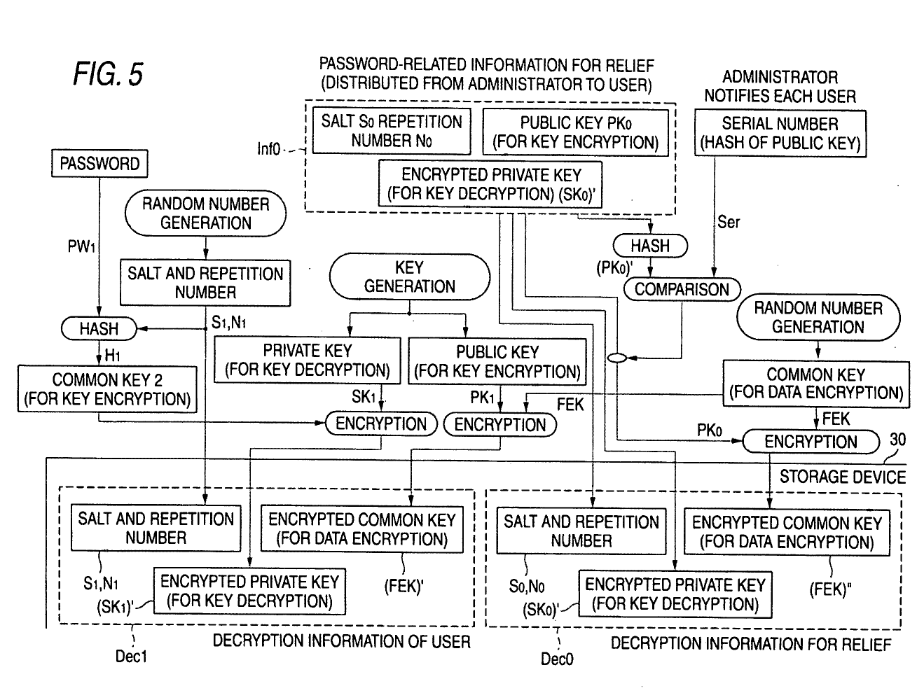

FIG. 4 is a flowchart showing the flow of an encryption initialization process executed by the user computer 20, and FIG. 5 is a view for explaining the management process. A timing at which this process is executed depends on how a unit area to be encrypted can be selected. For example, if the whole of the storage device 30 is assumed as a unit area, the process is executed when the initialization tool APL2 is installed on the user computer 20. Hereinafter, a description will be given of an example in which encryption is performed on the assumption that the whole of the storage device 30 is a unit area.

After the process is started, and password-related information Inf0 is obtained from the management computer 10 at step S200. In more detail, the user computer 20 communicates with the management computer 10 connected through a LAN in accordance with a communication protocol, such as TCP/IP, and the management tool APL1 executed in the management computer 10 is requested to transmit password-related information Inf0. The password-related information Inf0 transmitted from the management computer 10 is stored in, for example, the RAM 23.

At steps S210 to S230 subsequent to step S200, it is determined whether the password-related information Inf0 has been falsified or not. First, at step S210, a hash value is generated by a predetermined hash function from the public key PK0 of the password-related information Inf0, and the resulting hash value is temporarily stored on, for example, the RAM 23. The hash function used at this time is the same as the hash function used to generate the serial number Ser at step S150 of the above-mentioned management process. These hash functions are used under the same conditions (salt, repetition number, etc.). The generated hash value is displayed on the display device 28.

At step S220 subsequent to step S210, it is determined whether the hash value displayed at step S210 and the serial number Ser separately distributed coincide with each other. This determination is made by an ordinary user. Therefore, icons, such as “Coincidence” and “Non-coincidence”, are displayed together with the hash value displayed there, and selective input of any one of the icons by the operational input device 25 is awaited. Any one of the icons is selectively input, and the process proceeds to step S230.

At step 230 subsequent to step S220, the result of the selective input in step S220 is determined. If “Coincidence” is selected, it is determined that no falsification has been made, and the process proceeds to step S250. On the other hand, if “Non-coincidence” is selected, a warning indicating that a falsification may has been made is issued to the user, and the encryption initialization process is completed. Password-related information Inf0 may be again obtained from the management computer 10, and a determination thereof may be made at steps S210 to S230.

At step S240 subsequent to step S230, the key pair generation module M21 generates a pair of keys including a public key PK1 and a private key SK1. These keys are respectively used for encrypting and decrypting a common key FEK for data encryption to be stored on the storage device 30. The common key FEK encrypted with the public key PK1 can be decrypted with the private key SK1, and encrypted data can be decrypted with the common key FEK decrypted thereby.

At step S250 subsequent to step S240, the PW setting module M22 receives the input of an authentication password PW1. In more detail, the PW setting module M22 sets a series of characters input from the operational input device 25 as an authentication password PW1 for an ordinary user. This series of characters is input from the operational input device 25 during the period from the start of step S250 until the operational input showing the completion of the input of a password. If a login password for the user computer 20 or the like is appropriated for this password input, it is recommended at step S250 to obtain a login password written at a predetermined place of the user computer 20. When the input of the password of step S250 is completed, the process proceeds to step S260.

At step S260 subsequent to step S250, the private-key encrypting module M23 generates a hash value H1 from the authentication password PW1. The hash value H1 is generated from the authentication password PW1. According to the same method as the method for generating the hash value H0, the hash value H1 is generated by generating a salt S1 and a repetition number N1 from random numbers and using the generated salt S1 and repetition number N1.

At step S270 subsequent to step S260, the private-key encrypting module M23 encrypts the private key SK1 with the hash value H1, and generates an encrypted private key (SK1)′.

At step S280 subsequent to step S270, the common-key generation module M24 generates a common key FEK (i.e., an encryption key according to the common key encryption method) used to encrypt data. Random numbers generated by a predetermined random-number generation algorithm are used for the common key FEK. In other words, the common key FEK can achieve encryption by which data cannot be easily deciphered under a dictionary attack or a brute force attack.

At step S290 subsequent to step S280, the common-key encrypting module M25 generates an encrypted common key (FEK)′ by encrypting the common key FEK with the public key PK1 and also generates an encrypted common key (FEK)″ by encrypting the common key FEK with the public key PK0. Therefore, the common key FEK can be decrypted not only by the private key SK1 of an ordinary user “A” who is an encrypted-data generating person but also by the private key SK0 of an administrator.

At step S300 subsequent to step S290, the decryption information Dec1 of the user and the decryption information Dec0 of the administrator are stored in the storage device 30. The decryption information denotes a combination of information which allows the common key FEK to be decrypted in combination with the password set at step S110 or step S250. The decryption information Dec1 of the user includes the encrypted common key (FEK)′, the encrypted private key (SK1)′, the salt S1, and the repetition number N1. The decryption information Dec0 of the administrator includes the encrypted common key (FEK)″, the encrypted private key (SK0)′, the salt S0, and the repetition number N0.

Therefore, both the user and the administrator are not required to store decryption information on the management computer 10 or the user computer 20, and are released from management performed to back up the private key in preparation for data loss. Even if decryption information falls into the hands of a third party, it will be practically impossible to decrypt the common key FEK only from the decryption information. Therefore, security is not lowered. Additionally, there is no situation in which the private key is lost due to trouble in the management computer 10 or in the user computer 20.

Incidentally, in the flowchart of FIG. 4, the user determines at step S220 whether the hash value displayed on the display device 28 coincides with the serial number Ser separately distributed, and the user computer 20 determines at step S230 the coincidence of the serial number Ser and the displayed (generated) hash value based on the input from the user indicating the coincidence/non-coincidence. However, the determination of the coincidence is not limited thereto.

For example, after the user computer 20 generates the hash value at step S210, the user computer 20 may display a screen on the display device 28 to allow the user to input the serial number Ser. In case where the serial number is printed on a printable medium and delivered to the user, the user input a series of characters via the operational input device 25 while viewing the serial number Ser printed on the printable medium. The input of the series of characters may be performed by scanning the printed serial number by the scanner and then inputting the scanned data. In case where the serial number Ser is distributed via the storage device 200 or the removable storage device 210, the input of the series of characters is performed by retrieving the stored serial number Ser from the storage device 200 and the removable storage device 210. Then, the user computer 20 determines the coincidence between the generated hash value and the serial number Ser based on the series of characters input. In this case, the user computer 20 determines the coincidence. Also, the detection of the user input of coincidence/non-coincidence at step S230 may be interpreted as the user computer 20 determines the coincidence.

Through these steps, preparations for recording the encrypted data on the storage device 30 and for decoding the encrypted data recorded on the storage device 30 are completed.

### (4) Data Encryption/Decryption Process

The following is a description regarding data storage on and data acquisition from the storage device 30 after completion of the encryption initialization. An ordinary user and an administrator have a common flow in encryption/decryption except using different decryption information. Therefore, in the following description, an ordinary user is taken as an example.

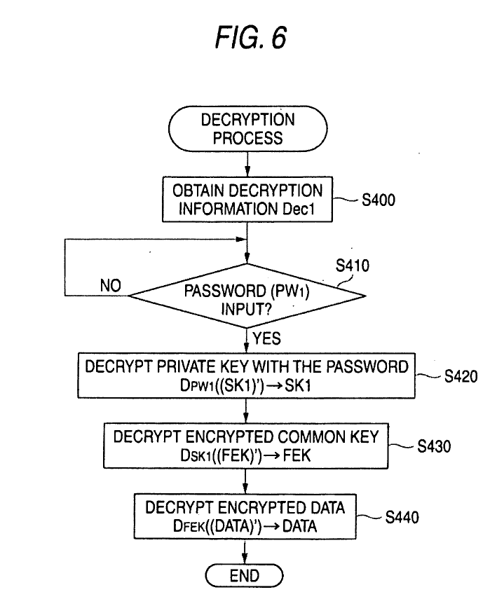

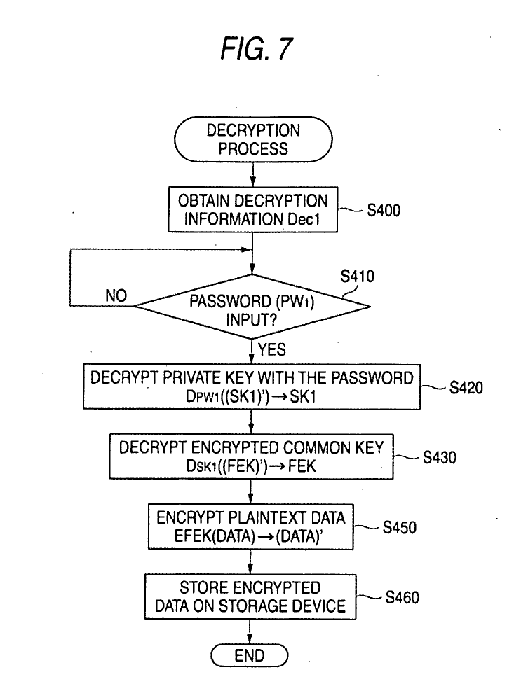

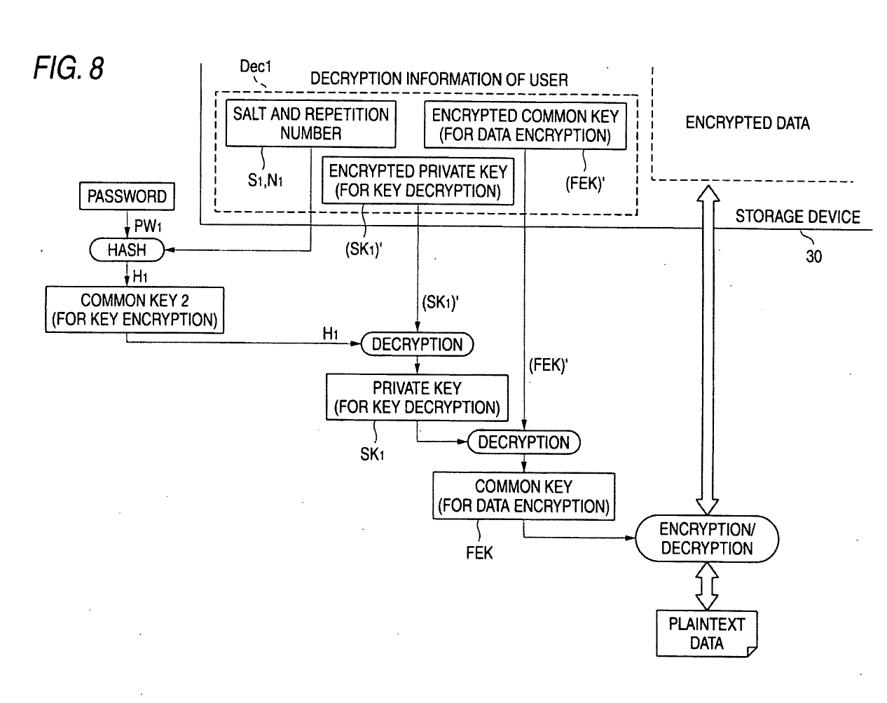

FIG. 6 is a flowchart showing the flow of the data encryption process, FIG. 7 is a flowchart showing the flow of the data decryption process, FIG. 8 is a view for explaining data decryption and data encryption by a user. In the encryption process and the decryption process, the same process steps are taken until a common key FEK is obtained. Therefore, the same step number is given to the same process step.

After the decryption/encryption process is started, decryption information Dec1 is obtained at step S400. In more detail, the data decrypting module M32 or the data encrypting module M31 obtains an encrypted common key (FEK)′, an encrypted private key (SK1)′, salt S1, and a repetition number N1 from the storage device 30.

At step S410 subsequent to step S400, the input of an authentication password PW1 is received. In more detail, the data encrypting module M31 or the data decrypting module M32 receives a series of characters input from the operational input device 25 during the period from the start of the step S410 until the operational input showing the completion of the input of a password. When the input of the password of step S410 is completed, the process proceeds to step S420.

At step S420 subsequent to step S410, the encrypted private key (SK1)′ is decrypted with the authentication password PW1. In more detail, an ordinary user is requested to input the authentication password PW1, and a hash calculation in which the salt S0 and the repetition number N0 are specified is performed by a predetermined hash function with respect to the authentication password PW1 input from the operational input device 25 by the operational input of the user. According to this calculation, a hash value H1 having used for encrypting the encrypted private key (SK1)′ is generated, and the private key SK1 is decrypted with the hash value H1.

At step S430 subsequent to step S420, the encrypted common key (FEK)′ is decrypted. That is, the common key FEK is decrypted with the private key SK1 that is decrypted at step S410.

After step S430 is completed, step S440 is executed in the decryption process, whereas steps S450 and S460 are executed in the encryption process.

In more detail, at step S440 of the decryption process, plaintext data is obtained by decrypting the encrypted data with the common key FEK. If a third party records data on the storage device 30, haphazard data is obtained by performing the decryption process with the password of the user. Specifically, if the password input from the operational input device 25 and received by the data decrypting module M32 is different from the password set by the PW setting module M22, the encrypted private key is not correctly decrypted and generates invalid private key. Then, if the plaintext data is encrypted with the invalid private key, the encrypted data can not be decrypted by the valid password i.e., the password set by the PW setting module M22. Therefore, it is possible to recognize the recording of the data performed by the third party can be recognized. Also, if the password received by the data decrypting module M32 input from the operational input device 25 is different from the password set by the PW setting module M12 or M22, the encrypted data is not correctly decrypted. Therefore, it is possible to prohibit the third party to decrypt the encrypted data.

On the other hand, at step S450 of the encryption process, the plaintext data is encrypted by use of the common key FEK. Thereafter, the encrypted data is stored on the storage device 30 at step S460.

As described above, the plaintext data can be encrypted with the decryption information obtained from the storage device 30 and the password PW1 input by each user, and the encrypted data can be stored on the storage device 30. Further, the encrypted data can be decrypted by the administrator and the user who has encrypted the data with only the information stored on the storage device 30. In the encryption and decryption, if each computer has an authentication tool installed thereon, the plaintext data can be obtained by decrypting the encrypted data with the password of each user from any one of the computers.

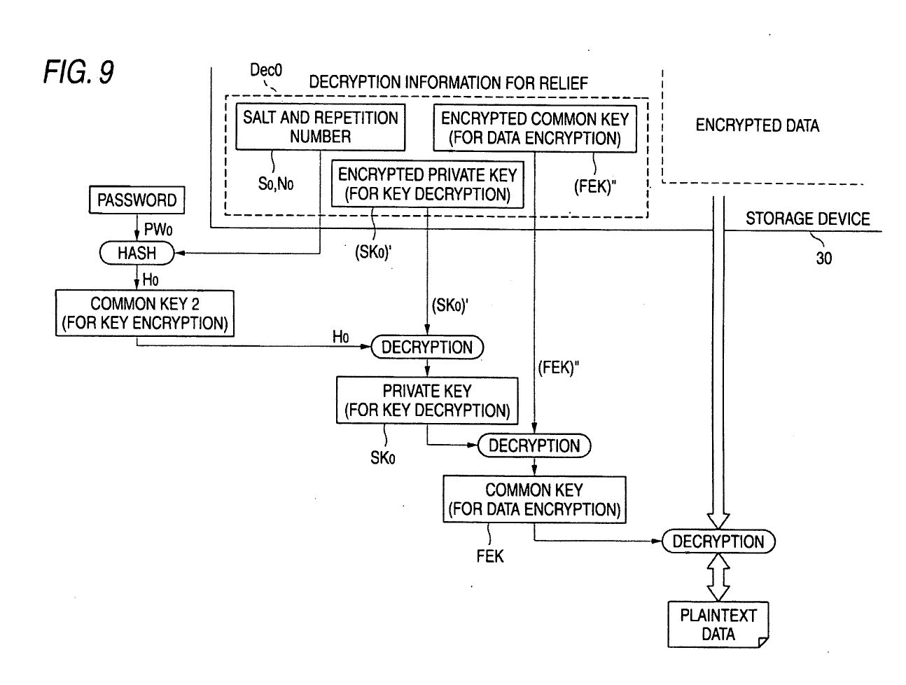

Further, the encrypted data is stored on the storage device 30 in association with the decryption information Dec0 of the administrator in addition to the decryption information Dec1, as described above. Therefore, the administrator is allowed to decrypt the encrypted data encrypted by the user computer 20. FIG. 9 is a view for explaining data decryption by the administrator. The decryption process by the administrator is similar to the process shown in FIG. 6, except the use of the decryption information Dec0 and the password PW0.

### (5) Various Modifications

The above-mentioned embodiment can be modified as follows.

1. The above-mentioned embodiment describes, as an example, an authentication system in which an administrator who has management privileges and a user who does not have management privileges exist. However, in the present invention, the administrator is not necessarily indispensable. For example, an authentication system may include a user computer and a storage device without a management computer. In this system, an encrypted common key and an encrypted private key for an administrator are not stored on the storage device 30, whereas an encrypted common key and an encrypted private key for a user are stored on the storage device 30. Therefore, this system can also avoid an increase of a time-consuming task for the management of encrypted data and a decrease in security and prevent a situation in which decryption cannot be executed in spite of the fact that encrypted data is present without being damaged.

2. The above-mentioned embodiment describes, as an example, a system including the management computer 10 and the user computer 20. However, the present invention can also be applied to a system operable by a plurality of users without an administrator. That is, the encrypted data is shared among users in this system. In this system, each user delivers password-related information (public key and encrypted private key of the user) to other users.

This example is described with reference to FIGS. 10B, 11, 12 and 13. In this illustrative example, the system includes user computers 20A and 20B respectively authorized to ordinary users A and B, and the user computer generates password-related information Inf1, which is generated by the same process shown in the above embodiment.

As shown in FIG. 10B, the password-related information Inf1 is output from the user computer 20A and input to another user computer 20B. The password-related information Inf1 may be delivered from the user computer 20A to the user computer 20B (from the user A to the user B) through various ways, as explained in the description relating to FIG. 10A. Although illustrated password-related information Inf1 includes an encrypted private key (SK1)′, a public key PK1, a salt S1 and a repetition number N1, the password-related information Inf1 may include at least the encrypted private key (SK1)′ and the public key PK1.

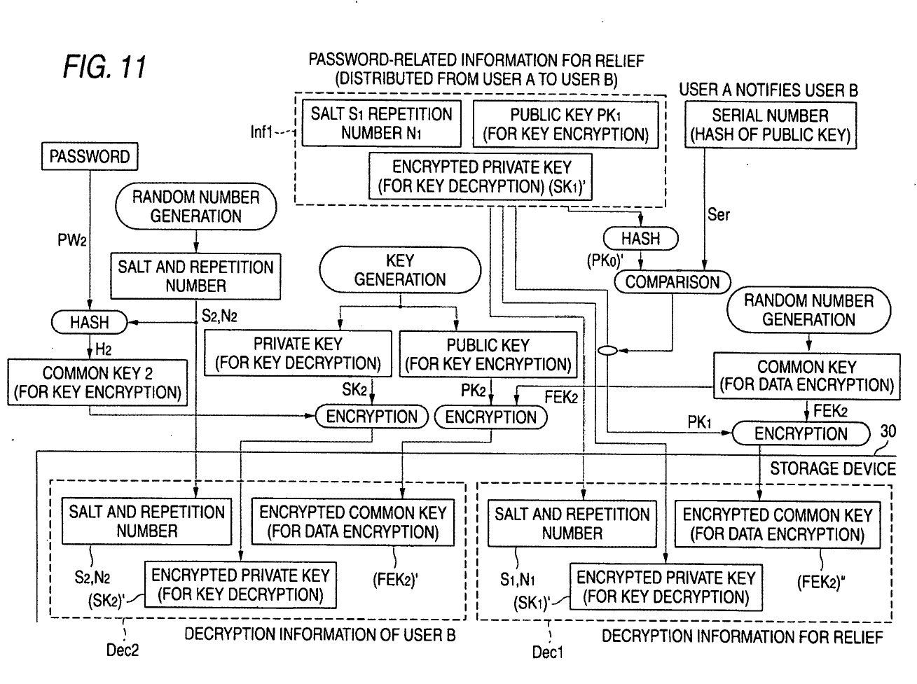

As shown in FIG. 11, the user computer 20B generates decryption information Dec2 based on a private key SK2, a public key PK2, a common key FEK2 and a password PW2, which relate to the user B, by similar process described in the above embodiment. In addition, the user computer 20B generates decryption information Dec1 based on the received password-related information Inf1 and the public key PK2 relating to the user B. Specifically, the user computer 20B encrypts the public key PK1 contained in the password-related information Inf1 with the common key FEK2 to generate an encrypted common key (FEK2)″. Similar to the above embodiment, a serial number Ser may be provided from the user A to the user B for higher security. Accordingly, the decryption information Dec1 is generated to include the encrypted secret key (SK1)′, the encrypted common key (FEK2)″, the salt S1 and the repetition number N1.

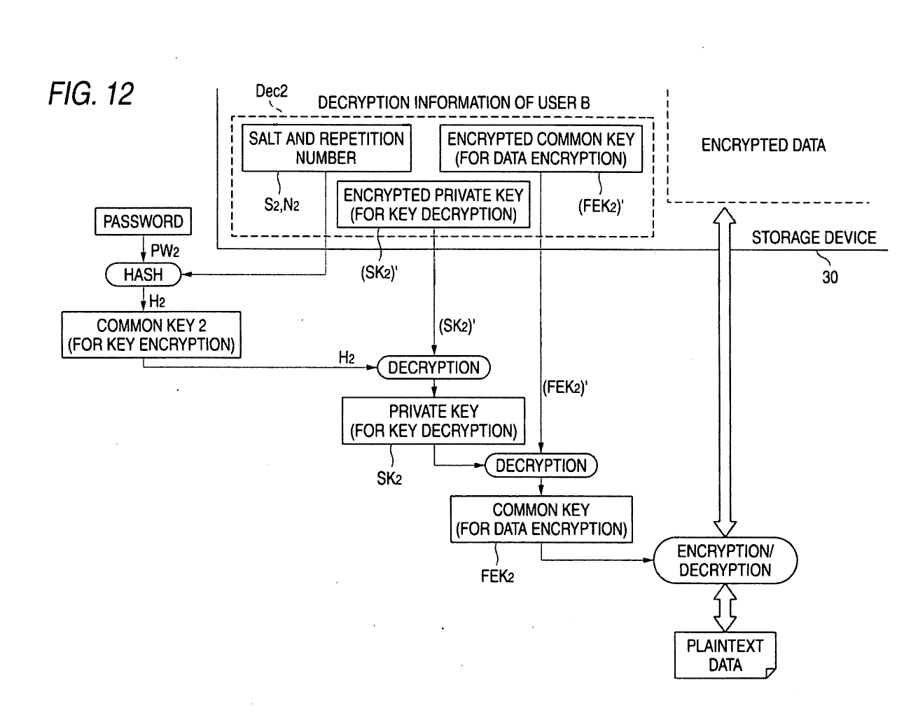

As shown in FIG. 12, when the user B who have received the password-related information Inf1 encrypts plaintext data with own common key FEK2 for data encryption and stores the encrypted data on the storage device 30, the user B also encrypts the common key FEK2 for data encryption with the public key PK1, then generates the encrypted common key (FEK2)″, and stores the encrypted data associated with the encrypted common key (FEK2)″ (the decryption information Dec2) thereon.

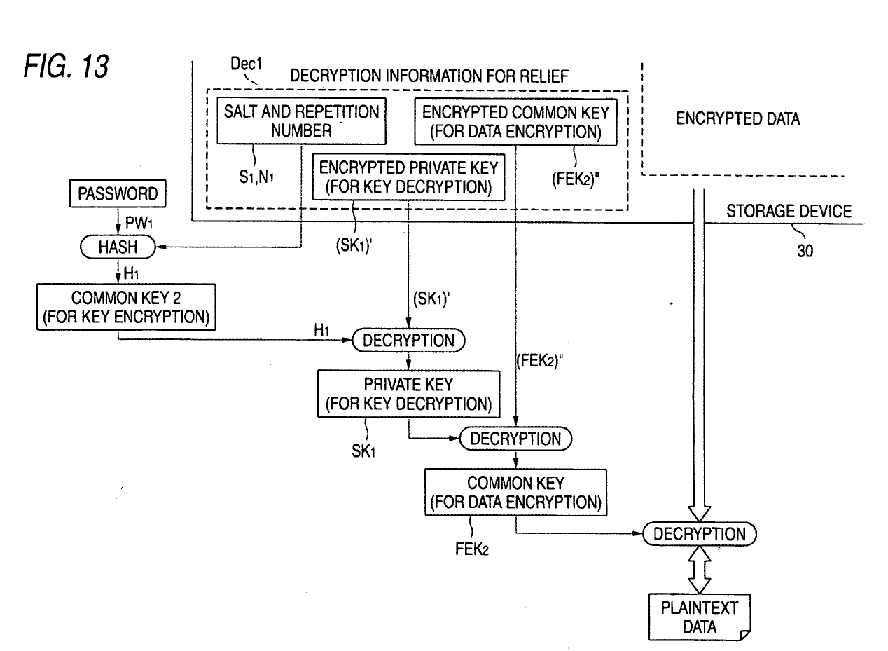

The encrypted data may also be associated with the decryption information Dec1. Therefore, as shown in FIG. 13, the user A can decrypt the encrypted data by using the decryption data Dec1 and the password PW1 of the user A.

Even if the password-related information Inf1 is leaked out to third parties, security will not be decreased, and the password-related information Inf1 can be safely delivered. Each user generates encrypted data such that other users can decrypt the data with the delivered key group. Of course, users may be ranked such that a higher-ranking user can decrypt encrypted data generated by a lower-ranking user, whereas a lower-ranking user cannot decrypt encrypted data generated by a higher-ranking user. Alternatively, a group of users may be formed such that encrypted data generated by a user belonging to this group can be decrypted only by users belonging to this group.

3. The above-mentioned embodiment describes a system in which program data on the management tool APL1, program data on the initialization tool APL2, and program data on the authentication tool APL3 are stored on the management computer 10 or the user computer 20. However, these program data may be stored on the storage device 30. When applications are executed, the program data is loaded into the management computer 10 or the user computer 20. If the storage device 30 includes a program-executing environment, these applications may be executed at the storage device 30. The program may not be loaded into the user computer or the management computer, and only the display of processing results may be transmitted to the user computer or the management computer in a similar process provided by an ASP (Application Service Provider).

4. The above-mentioned embodiment describes an example in which encrypted data that can be used between a single ordinary user and an administrator is generated. However, a plurality of ordinary users may be applicable. Further, the users accessible to the encrypted data generated once can be changed to add other ordinary users. To give an access right to the encrypted data to other ordinary users, a user-addition module may be built into the management tool APL1 and into the authentication tool APL3. An example of the process performed by the user-addition module is as follows. At first, steps S400 to S430 of the data encrypting module and the data decrypting module are executed to decrypt the common key FEK. Thereafter, the common key FEK is encrypted with a public key PK2 of an ordinary user “B” to generate an encrypted common key (FEK)′″. Furthermore, a private key SK2 is encrypted with a hash value H2 (salt S2 and repetition number N2) based on a password PW2 of the ordinary user “B”. Thereafter, the encrypted common key (FEK)′″, the encrypted private key (SK2)′, the salt S2, and the repetition number N2 are stored on the storage device 30 in the form of decryption information Dec2 for the ordinary user “B”.

5. In the above-mentioned embodiment, the password-related information Inf0 and Inf1 are generated at a timing when the management tool is initialized or when the initialization tool is installed. However, the password-related information may be generated every time a unit area to be encrypted is specified. However, the distribution of a serial number Ser used to prevent falsification with respect to the password-related information Inf0 of an administrator becomes unreal in proportion to an increase in the number of times the unit area is specified. In this case, it is recommended to allow the encrypted unit area to be specified only by each partition or each folder to suppress the increase in the number of times the unit area is specified.

6. The above-mentioned embodiment describes an example in which the whole of the storage device 30 is specified as a unit area. However, if a folder or a file in the storage device 30 is set as a unit area, the process will be executed when the encryption of each unit area is selected. At this time, the password-related information Inf0 may be acquired and checked, such as the process at steps S200 to S230, only at the first time or every time the encryption of each unit area is selected to obtain the password-related information Inf0 and to confirm whether the password-related information Inf0 has been falsified or not. If a folder or a file in the storage device 30 is set as a unit area in this way, decryption information different from one another is specified for each unit area. Therefore, the decryption information is specified not for the storage device 30 but for each unit area. Therefore, the each unit area has a file structure to have an area (e.g., header) used to store the decryption information.

7. In the above embodiment, the encrypted data is stored together with the encrypted private key, the encrypted common key, the salt and the repetition number on the same storage device 31. However, these data can be separately stored on different storage devices, as long as the separated data can be associated with one another. For example, the encrypted data may be stored on the removable storage device, and the encrypted private key, the encrypted common key, the salt and the repetition number may be stored on a server on a network. In this case, association information is attached to the encrypted data, wherein the association information indicates the stored location of the encrypted private key, the encrypted common key, the salt and the repetition number (e.g., address of the server).

The present invention is not limited to the above-mentioned embodiment and the modifications. The present invention also includes a form obtained by substituting the elements shown in the above-mentioned embodiment and the modifications with each other or by changing the combination of the elements shown therein, or includes a form obtained by substituting the elements shown in the known technique, the above-mentioned embodiment, and the modifications with one another or by changing the combination of the elements shown therein.

### [FIG. 1]

10: Management computer
DATA1: Program data
15: Operational input device
   Management tool APL1
M11: Key pair generation module
M12: PW setting module
M13: Private-key encrypting module
20: User computer
DATA2: Program data
(a): Plaintext data
25: Operational input device
   Initialization tool APL2
M21: Key pair generation module
M22: PW setting module
M23: Private-key encrypting module
M24: Common-key generation module
M25: Common-key encrypting module
   Authentication tool APL3
M31: Data encrypting module
M32: Data decrypting module
30: Storage device
31: Storage medium
   Encrypted private key (sk1)′
   Encrypted common key (FEK)′
   Salt S1
   Repetition number N1
   Encrypted private key (sk0)′
   Encrypted common key (FEK)″
   Salt S0
   Repetition number N0
   Encrypted data

### [FIG. 2]

(a) Management process
S100 Generate pair of public key PK0 and private key SK0
S110 Password (PW0) input?
S120 Generate hash value from password
   f(PW0)→H0
S130 Encrypt private key with the hash value
   EH0(SK0)→(SK0)′
S140 Store password-related information
   Inf0: (SK0)′, PK0, S0, N0
S150 Generate and distribute serial number g(PK0)→(PK0)′
(b) End

### [FIG. 3]

(a) Password
(b) random number generation
(c) Salt and repetition number
(d) Hash
(e) Private key 2 (for key encryption)
(f) Encryption
(g) Key generation
(h) Private key (for key decryption)
(i) Public key (for key encryption)
(j) Salt and repetition number
(k) Encrypted private key (for key decryption)
(l) Public key

### [FIG. 4]

(a) Encryption initialization process
S200 Obtain password-related information of the administrator
   S210 Generate hash value from public key of the administrator
   g (PK0)→H3
S220 Compare H3 with serial number Ser
S230 Coincide?
S240 Generate pair of public key and private key for user
S250 Password (PW1) input?
S260 Generate hash value from password
   f(PW1)→H1
S270 Encrypt private key with hash value
   EHO1(SK1)→(SK1)′
S280 Generate common key for data encryption
   FEK
S290 Encrypt FEK with public key
   EPK1(FEK)→(FEK)′
S300 Store decryption information of user and decryption information of administrator on the storage device
(b) End

### [FIG. 5]

(a) Password
(b) Hash
(c) Common key 2 (for key encryption)
(d) Random number generation
(e) Salt and repetition number
(f) Key generation
(g) Private key (for key decryption)
(h) Public key (for key encryption)
(i) Encryption
(j) Password-related information for relief (distributed from administrator to user)
(k) Salt S0
   repetition number N0
(l) Encrypted private key (for key decryption) (SK0)′
(m) Public key PK0 (for key encryption)
(n) Administrator notifies each user
(o) Serial number (hash of public key)
(p) Comparison
(q) Common key (for data encryption)
30: Storage device
Dec1: Decryption information of user
S1,N1: Salt and repetition number
(Sk1)′: Encrypted private key (for key decryption)
(FEK)′: Encrypted common key (for data encryption)
Dec0: Decryption information for relief
S0,N0: Salt and repetition number
(Sk0)′: Encrypted private key (for key decryption)
(FEK)″: Encrypted common key (for data encryption)

### [FIG. 6]

(a) Decryption process
S400 Obtain decryption information Dec1
S410 Password PW1 input?
S420 Decrypt private key with the password
DPW1((SK1)′)→SK1
S430 Decrypt encrypted common key
   DSK1((FEK)′)→FEK
S440 Decrypt encrypted data
   DFEK((DATA)′)→DATA
(b) End

### [FIG. 7]

(a) Encryption process
S400 Obtain decryption information Dec1
S410 Password PW1 input?
S420 Decrypt private key with password
   DPW1((SK1)′)→SK1
S430 Decrypt encrypted common key
   DSK1((FEK)′)→FEK
S450 Encrypt plaintext data
   EFEK(DATA)→(DATA)′
S460 Store encrypted data on storage device
(b) End

### [FIG. 8]

Dec1: Decryption information of user
S1,N1: Salt and repetition number
(SK1)′: Encrypted private key (for key decryption)
(FEK)′: Encrypted common key (for data encryption)
(a) Encrypted data
30: Storage device
(b) Password
(c) Hash
(d) Common key 2 (for key encryption)
(e) Decryption
SK1: Private key (for key decryption)
FEK: Common key (for data encryption)
(f) Encryption/decryption
(g) Plaintext data

### [FIG. 9]

Dec0: Decryption information for relief
S0,N0: Salt and repetition number
(SK0)′: Encrypted private key (for key decryption)
(FEK)″: Encrypted common key (for data encryption)
(a) Encrypted data
30: Storage device
(b) Password
(c) Hash
(d) Common key 2 (for key encryption)
(e) Decryption
SK0: Private key (for key decryption)
FEK: Common key (for data encryption)
(f) Plaintext data

### [FIG. 11]

(a) Password
(b) Hash
(c) Common key 2 (for key encryption)
(d) Random number generation
(e) Salt and repetition number
(f) Key generation
(g) Private key (for key decryption)
(h) Public key (for key encryption)
(i) Encryption
(j) Password-related information for relief (distributed from user A to user B)
(k) Salt S1
repetition number N1
(l) Encrypted private key (for key decryption) (SK1)′
(m) Public key PK1 (for key encryption)
(n) User A notifies user B
(o) Serial number (hash of public key)
(p) Comparison
(q) Common key (for data encryption)
30: Storage device
Dec2: Decryption information of user B
S2,N2: Salt and repetition number
(Sk2)′: Encrypted private key (for key decryption)
(FEK2)′: Encrypted common key (for data encryption)
Dec1: Decryption information for relief
S1,N1: Salt and repetition number
(Sk1)′: Encrypted private key (for key decryption)
(FEK2)″: Encrypted common key (for data encryption)

### [FIG. 12]

Dec2: Decryption information of user B
S2,N2: Salt and repetition number
(SK2)′: Encrypted private key (for key decryption)
(FEK2)′: Encrypted common key (for data encryption)
(a) Encrypted data
30: Storage device
(b) Password
(c) Hash
(d) Common key 2 (for key encryption)
(e) Decryption
SK2: Private key (for key decryption)
FEK2: Common key (for data encryption)
(f) Encryption/decryption
(g) Plaintext data

### [FIG. 13]

Dec1: Decryption information for relief
S1,N1: Salt and repetition number
(SK1)′: Encrypted private key (for key decryption)
(FEK2)″: Encrypted common key (for data encryption)
(a) Encrypted data
30: Storage device
(b) Password
(c) Hash
(d) Common key 2 (for key encryption)
(e) Decryption
SK1: Private key (for key decryption)
FEK2: Common key (for data encryption)
(f) Plaintext data

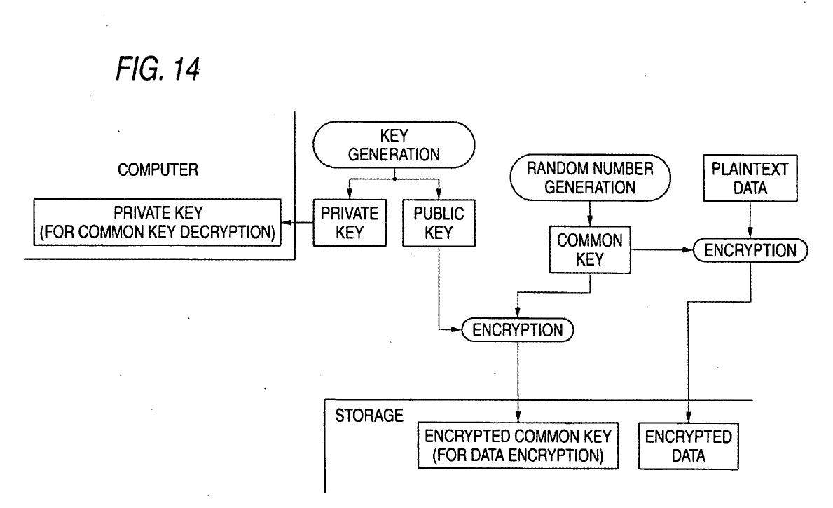

### [FIG. 14]

(a) Computer
(b) Private key (for common key decryption)
(c) Key generation
(d) Private key
(e) Public key
(f) Random number generation
(g) Common key
(h) Plaintext data
(i) Encryption
(j) Encryption
(k) Storage
(l) Encrypted common key (for data encryption)
(m) Encrypted data

What is claimed is:

1. A data management apparatus adaptable to an encryption system using a common key and a pair of keys comprising a public key and a private key, the encryption system in which: an encryption is performed by encrypting plaintext data with the common key to generate encrypted data and generate an encrypted common key by encrypting the common key with the public key; and decryption is performed by decrypting the encrypted common key with the private key to obtain a decrypted common key and decrypting the encrypted data with the decrypted common key, said data management apparatus comprising:
a common key encryption unit configured to encrypt a first common key with a first public key to generate an encrypted first common key;
a password setting receiving unit configured to receive a setting of a first password; and
a private key encryption unit configured to encrypt a first private key with the first password to generate an encrypted first private key.

2. The data management apparatus according to claim 1, further comprising:
a password input receiving unit configured to receive an input of a password; and
a data encrypting unit configured to:
decrypt the encrypted first private key with the input password to obtain a decrypted first private key;
decrypt the encrypted first common key with the decrypted first private key to obtain the decrypted first common key; and
encrypt a plaintext data with the decrypted first common key to generate encrypted data.

3. The data management apparatus according to claim 2, further comprising a storage control unit configured to store the encrypted data in association with the encrypted first private key and the encrypted first common key.

4. The data management apparatus according to claim 1, further comprising:
a decryption data obtaining unit configured to obtain encrypted data generated by encrypting plaintext data with the first common key, the encrypted first private key and the encrypted first common key;
a password input receiving unit configured to receive an input of a password; and
a data decryption unit configured to:
decrypt the encrypted first private key with the input password to obtain a decrypted first private key;
decrypt the encrypted first common key with the decrypted private key to obtain a decrypted first common key; and
decrypt the encrypted data with the decrypted first common key to obtain the plaintext data.

5. The data management apparatus according to claim 1, wherein the private key encryption unit is configured to calculate a hash value from the first password by a predetermined hash function and encrypt the first private key with the hash value.

6. The data management apparatus according to claim 1, further comprising:
a hash condition generating unit configured to generate a salt and a repetition number from predetermined random numbers; and
a storage control unit,
wherein the private key encryption unit is configured to generate a hash value from the first password by a predetermined hash function by use of the salt and the repetition number, and
wherein the storage control unit is configured to store the salt and the repetition number in association with the encrypted first common key and the encrypted first private key.

7. The data management apparatus according to claim 1, further comprising an output unit configured to output the first public key and the encrypted first private key to another data management apparatus.

8. The data management apparatus according to claim 7, further comprising:
a decryption data obtaining unit configured to obtain the encrypted first private key, an encrypted second common key generated by encrypting a second common key with the first public key, and encrypted data generated by encrypting plaintext data with the second common key;
a password input receiving unit configured to receive an input of a password; and
a data decryption unit configured to:
decrypt the encrypted first private key with the input password to obtain a decrypted first private key;
decrypt the encrypted second common key with the decrypted private key to obtain a decrypted second common key; and
decrypt the encrypted data with the decrypted second common key to obtain the plaintext data.

9. The data management apparatus according to claim 1, wherein the common key encryption unit comprises:
a hash generating unit configured to calculate a hash value from the first public key by a predetermined hash function;
a first output unit configured to output the hash value; and
a second output unit configured to output the first public key.

10. The data management apparatus according to claim 1, further comprising an obtaining unit configured to obtain an encrypted second private key and a second public key, the encrypted second private key being generated by encrypting a second private key with a second password, the second private key and the second public key being unique from the first private key and the first public key,
wherein the common key encryption unit is configured to encrypt the first common key with the second public key to generate a relief encrypted first common key.

11. The data management apparatus according to claim 10, further comprising a storage control unit configured to store the encrypted first common key and the encrypted first common key as first decryption information and store the relief encrypted first common key and the encrypted second private key as second decryption information.

12. The data management apparatus according to claim 11, further comprising:
a password input receiving unit configured to receive an input of an input password; and
a data encrypting unit configured to:
decrypt the encrypted first private key with the input password to obtain a decrypted first private key;
decrypt the encrypted fist common key with the decrypted first private key to obtain the decrypted first common key; and
encrypt a plaintext data with the decrypted first common key to generate an encrypted data,
wherein the storage control unit configured to store the encrypted data in association with the first decryption information and the second decryption information.

13. The data management apparatus according to claim 10, further comprising:
a hash generating unit configured to calculate a hash value from the obtained second public key by a predetermined hash function; and
a determination unit configured to determine whether the hash value coincides with a second hash value calculated from an original second public key by the predetermined hash function, the original second public key corresponding to the second public key but having been generated before the obtaining unit obtains the second public key;
wherein the common key encryption unit encrypts the first common key with the second public key to generate a relief encrypted first common key if the determination unit determines that the hash value coincides with the second hash value.

14. A data management method adaptable to an encryption system using a common key and a pair of keys comprising a public key and a private key, the encryption system in which: an encryption is performed by encrypting plaintext data with the common key to generate encrypted data and generating an encrypted common key by encrypting the common key with the public key; and decryption is performed by decrypting the encrypted common key with the private key to obtain a decrypted common key and decrypting the encrypted data with the decrypted common key, said data management method comprising:
encrypting a first common key with a first public key to generate an encrypted first common key;
receiving a setting of a first password; and
encrypting a first private key with the first password to generate an encrypted first private key.

15. A computer-readable medium having a computer program stored thereon and readable by a computer, said computer program, when executed by the computer, causes the computer to perform operations for a data management apparatus adaptable to an encryption system using a common key and a pair of keys comprising a public key and a private key, the encryption system in which: an encryption is performed by encrypting plaintext data with the common key to generate encrypted data and generating an encrypted common key by encrypting the common key with the public key; and decryption is performed by decrypting the encrypted common key with the private key to obtain a decrypted common key and decrypting the encrypted data with the decrypted common key, said operations comprising:
encrypting a first common key with a first public key to generate an encrypted first common key;
receiving a setting of a first password; and
encrypting a first private key with the first password to generate an encrypted first private key.
